(19) United States
(12) Patent Application Publication
(10) Pub. No.: US 2024/0385141 A1
(43) Pub. Date: Nov. 21, 2024

(54) METHOD AND DEVICE FOR DETECTING A DEFECT USING ULTRASOUND

(71) Applicant: SAINT-GOBAIN CENTRE DE RECHERCHES ET D'ETUDES EUROPEEN, COURBEVOIE (FR)

(72) Inventors: Sébastien PINSON, CAVAILLON (FR); Cédric PAYAN, CAVAILLON (FR); Mickael BOINET, CAVAILLON (FR)

(21) Appl. No.: 18/696,081

(22) PCT Filed: Sep. 29, 2022
(86) PCT No.: PCT/EP2022/077189

§ 371 Date: Mar. 27, 2024

(30) Foreign Application Priority Data
Sep. 30, 2021 (FR) 2110340

(51) Int. Cl. G01N 29/04; G01N 29/12; G01N 29/30; G01N 29/42; G01N 29/44; G01N 29/46

(52) U.S. Cl. CPC G01N 29/043; G01N 29/12; G01N 29/30; G01N 29/42; G01N 29/4472; G01N 29/46; G01N 2291/014; G01N 2291/02491; G01N 2291/02818; G01N 2291/02827

(57) ABSTRACT

A method for detecting a defect in a region of interest within a part to be tested includes the step of,
for a reference part identical to the part to be tested but free from defects, determining a set of resonant modes each defining:
a resonant frequency of the reference part, considering that the modulus of elasticity of the reference part is constant, and
a field of mechanical stresses on and/or in the reference part that are generated when the reference part resonates at the resonant frequency. The method includes
selecting the resonant mode, referred to as “optimum resonant mode”, that generates, in the region of interest, a maximum mechanical stress and
determining a loading mode, referred to as “optimum” loading mode, that primarily activates the optimum resonant mode, a loading mode defining at least an excitation wave, an injection zone where the excitation wave is injected into the reference part, and an output zone where an output wave resulting from the excitation wave passing through from the injection zone to the output zone is picked up. The method includes
carrying out nonlinear resonant spectrometry analysis based on the optimum loading mode, so as to determine a nonlinearity parameter for each of the part to be tested and reference part and classifying the part to be tested on the basis of the difference between the nonlinearity parameters for the part to be tested and for the reference part.”

### TECHNICAL FIELD

The invention relates to a method for detecting a defect in a part, in particular a ceramic or glass-ceramic part.

### PRIOR ART

The detection of internal defects in a part through acoustic wave analysis is known.

The oldest method is that of measuring and analyzing the speed of transmission of an acoustic wave in the part. However, its field of application is limited to parts with a simple shape and consisting of a homogeneous and uniform material. It is also known to analyze the attenuation of the injected acoustic wave through linear analysis, that is to say considering that, in a given environment, the resonant frequencies depend exclusively on the part, namely on its shape and its constituent material (which determines the speed of the waves). However, this type of analysis has also shown its limitations in terms of discriminating parts with a complex structure or made of a heterogeneous material.

Nonlinear resonant ultrasound spectroscopy (NRUS) or, more generally, nonlinear resonant acoustic spectroscopy (NRAS) are more recent methods that exploit the fact that the modulus of elasticity of the material constituting the part is not constant, but varies as a function of the mechanical stresses generated in the part by the excitation wave. The resonant frequencies thus depend on the amplitude of the excitation wave. This method is based in particular on analysis of the evolution of the resonant frequency spectrum as a function of the amplitude of the injected wave.

Typically, if, in a given loading mode,
fₒ is the initial linear resonant frequency of the part, that is to say considering that the modulus of elasticity of the part is constant, the linear resonant frequency conventionally being evaluated by numerical simulation or measured by analyzing the response to the injection of a low-amplitude wave in said loading mode, and
f is the resonant frequency measured for waves of greater amplitude than the excitation wave,

the method evaluates the frequency offset |f−fₒ|/fₒ as a function of said amplitude. It then exploits a difference in evolution of the frequency offset according to the presence or absence of damage, as described in U.S. Pat. No. 6,330,827B1.

Application FR2960061 A1 describes the use of the NRUS technique to explore the domain of nonlinear elasticity of materials such as rocks.

However, the inventors have discovered that the application of the NRUS technique described in the prior art is not always reliable, in particular if the part is of complex shape. Furthermore, in the simultaneous presence of multiple defects, for example physical defects (such as a crack) and chemical defects (such as a local change in elemental composition or crystallographic phase), the frequency offsets induced by these defects may compensate for one another.

There is therefore a need for a method for detecting a defect in a part that exhibits improved reliability, even when this part has a complex geometry and/or a complex internal structure or when it exhibits multiple defects.

One aim of the invention is to meet this need, at least partially.

### SUMMARY OF THE INVENTION

More specifically, one subject of the present invention is a method for detecting a defect in a region of interest within a part to be tested, said method comprising the following successive steps:
a) for a reference part identical to the part to be tested but free from defects,
   a1) preferably using numerical simulation, determining a set of resonant modes each defining:
a resonant frequency of the reference part, considering that the modulus of elasticity of the reference part is constant, and
a field of mechanical stresses or deformations on and/or in the reference part that are generated when the reference part resonates at said resonant frequency;
a2) selecting the resonant mode, referred to as “optimum resonant mode”, that generates, in the region of interest, a maximum mechanical stress or deformation compared to the other resonant modes;
b) determining a loading mode, referred to as “optimum” loading mode, that primarily activates said optimum resonant mode, a loading mode defining at least an excitation wave, an injection zone where the excitation wave is injected into the reference part, and an output zone where an output wave resulting from the excitation wave passing through from the injection zone to the output zone is picked up;
c) carrying out nonlinear resonant spectrometry analysis based on the optimum loading mode, so as to determine a nonlinearity parameter for each of said part to be tested and reference part;
d) classifying the part to be tested on the basis of the difference between the nonlinearity parameters for the part to be tested and for the reference part.

As will be seen in more detail in the remainder of the description, the inventors have discovered that the selection of an optimum resonant frequency as a function of the region of interest considerably improves the reliability of the detection of a defect through nonlinear resonant spectroscopy when this is carried out based on a loading mode that primarily activates the corresponding optimum resonant mode. In particular, the detection is reliable for a part with a complex internal shape or structure.

Remarkably, focusing on the region of interest leads to determining an optimum resonant frequency that is not necessarily the resonant frequency that leads to the most mechanical stresses or deformations of the reference part considered as a whole.

Determining resonant modes through numerical simulation while considering that the modulus of elasticity is constant (linear acoustics) also advantageously makes it possible to identify the optimum resonant mode quickly and reliably. The method may thus be implemented for example on a production line requiring a response time of less than 10 seconds, or even less than one second.

Nonlinear resonant spectrometry analysis based on the optimum loading mode may conventionally be carried out by applying, to the part under consideration (part to be tested or reference part), the optimum loading mode and derived loading modes that differ from the optimum loading mode only in terms of the amplitude of the injected excitation wave. This is followed by examining the evolution of the resonant frequency, starting from the optimum resonant frequency, under the effect of the evolution of said amplitude, in order to determine the nonlinearity parameter.

For the reference part, a loading mode may be applied to the part itself or to a numerical model of the part.

Preferably, a method according to the invention has one or more of the following optional features:
in step a1), the resonant modes are determined through numerical simulation, the modeling of the reference part taking into account the dimensions and the geometry of the reference part, the bulk density of the material constituting the reference part, the modulus of elasticity of said material, and the Poisson's ratio of said material;
in step a2), three-dimensional numerical models of the reference part are compared, said models each representing a field of said mechanical stresses or deformations generated when the reference part resonates at a respective resonant frequency;
the volume of the region of interest is less than 0.2 times and greater than 0.01 times the volume of the reference part;
steps a) and b) are carried out simultaneously, the optimum loading mode being sought as follows:
   numerically simulating a plurality of loading modes, the numerical simulation determining, for each loading mode, a mechanical stress field in the reference part and a theoretical output wave (that is to say a simulation of the output wave in this loading mode);
   analyzing the mechanical stress fields and the theoretical output waves so as to select, as optimum loading mode, the loading mode that generates, in the region of interest, a maximum mechanical stress or deformation and sets the reference part in resonance;
in step c), the nonlinearity parameter is the slope of a straight line representative of the evolution of a frequency offset as a function of the evolution of the amplitude of the output wave when said amplitude of the output wave is modified, preferably increased, from the optimum loading mode,
the frequency offset, for an amplitude of the output wave, being the ratio of the absolute value of the difference between the optimum resonant frequency (fₒ) in the optimum resonant mode and the resonant frequency (f) determined for said amplitude of the output wave, divided by the optimum resonant frequency (fₒ);
in step d), the nonlinearity parameter of the part to be tested is compared with a threshold determined based on the nonlinearity parameter of the reference part, and the part to be tested is then classified on the basis of the difference between the nonlinearity parameter of the part to be tested and the threshold, preferably on the basis of the sign of said difference;
the defect is an empty space within the part to be tested, or a space filled with a material different from the rest of the part to be tested;
the part is made of an inorganic material;
the part is made of a metal, preferably a sintered metal, a ceramic material, a glass-ceramic material, a glass or of a mixture of these materials, in particular a composite;
in the optimum loading mode, the main peak of a frequency spectrum of the output wave is at a frequency between 1 Hz and 200 kHz, preferably less than 100 kHz, preferably greater than 20 kHz;
the output wave is an acoustic wave;
the part to be tested is chosen from:
   a throat lintel or block,
   a soldier block,
   a refractory brick or sidewall block,
   a corner block,
   a tuckstone,
   a paving tile or pavement,
   a crown brick or beam,
   a tuyere surround block or brick,
   a brick for a tapping hole or spout,
   an electrode block,
   a refractory spout-lip for a glass furnace,
   a block for an injector,
   a glass furnace throat,
   a part for a heat exchanger of a furnace,
   a boiler lining refractory tile or plate,
   a shell for protecting a heater tube for an incinerator,
   an incinerator tile,
   a ceramic part for a solar absorber,
   a protective part or tile for a turbine combustion chamber.

The deformation of a part is the result of the application of a corresponding mechanical stress. In the context of the present invention, mechanical stresses and mechanical deformations are therefore equivalent. For the sake of clarity, the remainder of the description mentions only mechanical stresses. However, this description is applicable for mechanical deformations.

The invention also relates to a method for sorting externally identical parts manufactured on a production line, wherein a detection method according to the invention is implemented for each part, considered to be a part to be tested, steps a) and b) and the nonlinear resonant spectrometry analysis based on the optimum loading mode carried out on the reference part preferably being common to the set of parts. The set of parts may comprise for example more than 10, more than 100 or more than 1000 parts to be tested.

Finally, the invention relates to a detection device intended to detect a defect in a part to be tested, the device comprising:
a resonator able to inject, into the part to be tested, an excitation wave through an injection zone of the part to be tested;
a receiver able to pick up an output wave through an output zone of the part to be tested, the output wave resulting from the excitation wave passing through the part to be tested;
a computer connected to the receiver so as to receive the output wave, the computer having a memory storing a nonlinearity parameter resulting from nonlinear resonant spectrometry analysis carried out, in accordance with step c), based on an optimum loading mode determined in accordance with steps a) and b), for a reference part identical to the part to be tested but free from defects, the computer being programmed to
carry out said nonlinear resonant spectrometry analysis for the part to be tested, based on the optimum loading mode in accordance with step c), so as to determine the nonlinearity parameter for said part to be tested, and then
determine a difference between the nonlinearity parameters for the part to be tested and for the reference part, and then
classify the part to be tested on the basis of said difference.

In one preferred embodiment, the nonlinearity parameter for the reference part is determined with the computer, in accordance with steps a) and b).

Of course, the optional features of steps a) to d) described for a method according to the invention are applicable to the corresponding steps implemented by the computer.

Preferably, the operator proceeds as follows:
carrying out steps a) and b) and, for the reference part, step c);
positioning the resonator and the receiver on the injection and output zones, respectively;
injecting the excitation wave so as to load the part to be tested in the optimum loading mode;
launching a computer program so as to carry out step c) for the part to be tested, and then step d).

### BRIEF DESCRIPTION OF THE FIGURES

Other features and advantages of the invention will emerge more clearly upon reading the following detailed description and on examining the appended drawing, in which:

FIG. 1 is a photo of a ceramic part with a complex shape, in this case a photo of a forehearth tank part of a glass furnace;

FIG. 2 shows, for a rectangular parallelepipedal part, the enriched models for six resonant modes;

FIG. 3 schematically illustrates an optimum loading mode for said rectangular parallelepipedal part, along with a detection device according to the invention;

FIG. 4 shows a portion of a frequency spectrum for the output wave received in the output zone in the optimum loading mode of FIG. 3;

FIG. 5 illustrates the evolution of the frequency offset, on the ordinate, as a function of the amplitude of the output wave, for eight nitride-bonded corundum parts of the same shape, starting, in order to carry out the nonlinear resonant spectrometry analysis, from a non-optimum loading mode, according to the prior art (graph on the left), and an optimum loading mode, according to the invention (graph on the right), the two ovals in broken lines grouping together parts exhibiting a defect (“crack”) and parts not exhibiting a defect (“sound”), respectively;

FIG. 6 provides the nonlinear parameters defined based on the graphs on the left (left-hand graph in FIG. 6) and on the right (right-hand graph in FIG. 6) of FIG. 5, respectively;

FIG. 7 shows, for the part that is the subject of the first example, the enriched models for four resonant modes;

FIG. 8 illustrates the selectivity enabled by a method according to the invention, as described for the second example.

In the various figures, identical references are used to designate identical or similar members.

### Definitions

The amplitude of a wave is conventionally the height of the main peak of a frequency spectrum of said wave, the main peak being the highest peak.

Unless indicated otherwise, all percentages relating to the compositions are percentages by mass.

The total porosity is conventionally equal to 100×(absolute density−bulk density)/absolute density.

The bulk densities are measured according to the ISO 5017 standard on a bar taken from the core of the part, in a healthy zone. The absolute density is conventionally measured on ground powder, using a helium pycnometer.

“Have”, “exhibit” or “comprise” should be interpreted broadly and without limitation.

### DETAILED DESCRIPTION

A method according to the invention may be implemented in order to detect a defect in any part to be tested. It is particularly well-suited to a part to be tested comprising, preferably consisting of, an inorganic material, preferably a sintered metal, a ceramic or a glass-ceramic.

Preferably, the part to be tested is made of a refractory material, that is to say of a non-metallic inorganic material, for example a molten or sintered material.

Preferably, the modulus of elasticity (MOE) of the part to be tested is between 1 and 500 GPa, preferably between 5 and 100 GPa, at room temperature.

Preferably, the bulk density of the part to be tested is between 0.5 and 10 g/cm³, preferably between 1 and 6 g/cm³.

The part to be tested may be one block or a rigid assembly of blocks.

In particular, it may weigh more than 0.5 kg, more than 1 kg, more than 5 kg and/or less than 1000 kg, less than 100 kg, less than 50 kg or less than 20 kg.

The part to be tested is preferably chosen from:
a throat lintel or block,
a soldier block,
a refractory brick or sidewall block,
a corner block,
a tuckstone,
a paving tile or pavement,
a crown brick or beam,
a tuyere surround block or brick,
a brick for a tapping hole or spout,
an electrode block,
a refractory spout-lip for a glass furnace,
a block for an injector,
a glass furnace throat,
a part for a heat exchanger of a furnace,
a boiler lining refractory tile or plate,
a shell for protecting a heater tube for an incinerator,
an incinerator tile,
a ceramic part for a solar absorber,
a protective part or tile for a turbine combustion chamber.

The defect is a local and more often than not undesirable modification of:
the geometry of the part to be tested; or
the chemical composition of the part to be tested; or
the microstructure of the part to be tested.

The defect may in particular be an empty space or a space filled with a material different from the rest of the part. For example, it may be a crack, a void or an inclusion.

The defect may also be a chemical or structural variation, in particular a crystallographic variation.

The defect may have any dimensions. In particular, its largest dimension (length) may be between 1 μm and 100 mm.

Prior to step a), the method may include determining the region of interest, that is to say a region inside the part to be tested and in which the probability of occurrence of a defect is high.

In particular, experience may highlight a region of the parts in which defects appear repeatedly. Such a region may be chosen as a region of interest. Observing the presence of a defect in a part may require destroying the part, for example by cutting and observation along multiple sectional planes. A non-destructive method, such as radiography or tomography, may also be used to observe the presence of a defect, if the dimensions of the part allow this.

It is also possible to carry out local analysis, for example a local elemental chemical measurement on a sample taken from the part, for example by way of a microscope equipped with an EDS or EDX probe or by way of phase analysis, for example through X-ray diffraction.

The region of interest may have any shape.

When the general shape of the defect to be detected is known, the region of interest is preferably determined so as to encompass the defect, preferably as precisely as possible. The volume of the region of interest is preferably greater than that of the defect. It is preferably less than 5 times, 3 times, 2 times or 1.5 times the volume of the defect.

When the shape of the defect to be detected is known, the region of interest preferably has a similar shape in which the defect extends.

The volume of the region of interest is preferably less than 1000 cm³ and/or greater than 0.1 cm³.

The volume of the region of interest is preferably less than 0.5 times, preferably less than 0.3 times, preferably less than 0.2 times, preferably less than 0.1 times, preferably less than 0.05 times, and/or greater than 0.01 times the volume of the part to be tested.

In one embodiment, the region of interest is delimited by a volume of revolution within which the defect is inscribed. Depending on the shape of the defect, the volume of revolution may be a cylinder (in the case of an elongate defect in a single dimension in space) or a sphere.

In step a), a reference part is analyzed in order to find an optimum resonant mode.

The reference part is a part identical to the part to be tested, except possibly in the region in which the defect is sought, that is to say in the region of interest. The term “identical” is understood to mean “having substantially the same geometry (that is to say the same shape), to within manufacturing tolerances, and made of the same material (same composition, same microstructure), to within variations due to the raw materials and to the performance of the manufacturing process”. Manufacturing dimensional tolerances are conventionally less than one millimeter in the refractory industry, and less than 100 microns in the technical ceramics industry. Compositional tolerances are conventionally +/−5% for a component whose content is greater than 30% by mass, and less than +/−1% for another component.

Since the reference part has the same general shape as the part to be tested, for the sake of clarity, the name “region of interest” is also given to the equivalent region of the reference part, that is to say the region that would overlap the region of interest of the part to be tested if the latter were able to be “superimposed” with the reference part so as to be coincident therewith.

In step a1), preferably with suitable software and a computer, resonant modes of the reference part are determined, considering that the modulus of elasticity of the reference part is constant (linear acoustics). Each resonant mode defines a resonant frequency of the reference part and a mechanical stress field generated when the reference part resonates at said resonant frequency.

Conventional software, for example COMSOL® or Abacus®, is preferably used.

Conventionally, a numerical model of the reference part is first generated. Such a model is a three-dimensional representation in space of the reference part. The dimensions and the geometry of the reference part are defined by a mesh of points, or “voxels”.

Preferably, the mesh density, or “volume density of the mesh points”, is defined such that at least one point of the mesh is present in the region of interest.

Preferably, at least the bulk density of the material constituting the reference part, the modulus of elasticity of said material and its Poisson's ratio are entered into the software.

Those skilled in the art know how to determine bulk density. For example, for a material made of a ceramic, a metal or a glass, it may be measured directly on the reference part or on a sample of the part in accordance with the ISO 5017 standard. Modulus of elasticity may be measured through dynamic tests, preferably in accordance with the ASTM C1259-01 standard, in particular for a ceramic reference part for which the Poisson's ratio is generally equal to 0.2.

Conventionally, the software, by way of a finite element calculation and at a plurality of points of the reference part, preferably at least on the surface of the reference part, determines the mechanical stresses, in particular tractive and/or tensile stresses, and/or compressive and/or torsional and/or shear stresses, in various directions. As an alternative or in addition, the software may determine a property equivalent to mechanical stresses, such as a deformation.

The software may calculate the absolute value of a mechanical stress, or a relative value calculated with respect to the value at a predefined location of the reference part. Moreover, at one point of the part, the mechanical stresses vary over time under the effect of the excitation wave. For example, the software may provide the mean or maximum value of a mechanical stress or the amplitude of its variation.

Preferably, the software presents the mechanical stresses in the form of graphs, preferably in the form of an “enriched” model the appearance of which, for example the color, depends locally on the local mechanical stress. A view of an enriched model is therefore a map representing a stress field.

In one embodiment, the local mechanical stresses are represented only on the surface of the model. In one embodiment, the software makes it possible to generate cutting planes and to visualize local mechanical stresses in the cutting plane.

The number of resonant modes determined may be greater than 3, 5, 10 and/or less than 30 or 20. Conventionally, it is possible to enter this number into the software so that it provides the main resonant modes.

In step a2), the “optimum” resonant mode that generates a maximum mechanical stress in the region of interest is selected from among the resonant modes determined in step a1). In other words, in the region of interest, it is the optimum resonant mode that produces the greatest mechanical stress (or mechanical deformation) compared to those produced in the other resonant modes in said region of interest.

Advantageously, a simple visual comparison between the various enriched models, obtained for the various resonant modes, makes it possible to immediately identify the resonant mode that generates maximum stresses in the region of interest of the reference part, and therefore to determine the associated resonant frequency, referred to as “optimum” resonant frequency.

Multiple resonant modes may generate maximum stresses in the region of interest of the reference part. In this exceptional situation, the optimum resonant mode is preferably the resonant mode that is easiest to implement in practice.

The inventors have discovered that steps a1) to a2) make it possible to define an optimum resonant mode that makes it possible, through known NRUS or NRAS nonlinear resonant spectrometry analyses, to detect a defect in the part to be tested in a particularly reliable manner.

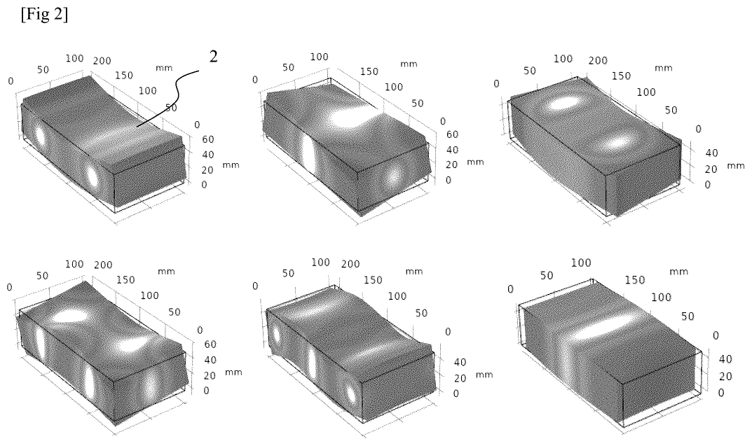

FIG. 2 shows, for six resonant modes, the corresponding enriched models obtained with the COMSOL® software, for a rectangular parallelepipedal block 2. Each enriched model shows, in grayscale, the local deformation at the surface of the block, for a respective resonant mode. The darker the gray, the greater the deformation. In one and the same region, it is immediately observed that the local deformations, and therefore the local mechanical stresses, vary considerably as a function of the resonant mode under consideration.

For a region of interest in the center of the block, it is immediately apparent that the first resonant mode (top-left model) is the optimum resonant mode.

In step b), an optimum loading mode that primarily activates said optimum resonant mode is first determined.

A loading mode defines conditions under which a part is set in vibration, that is to say specifies, for a vibrational state, the excitation conditions needed to obtain this vibrational state. A loading mode may thus specify
an injection zone, that is to say a zone on the surface of the part via which an excitation wave enters the part,
an output zone, that is to say a zone on the surface of the part by which the excitation wave is received after having passed at least partially through the part, this wave being then called “output wave”, and
the characteristics of the excitation wave, which, when it is injected via the injection zone, bring about the vibrational state.

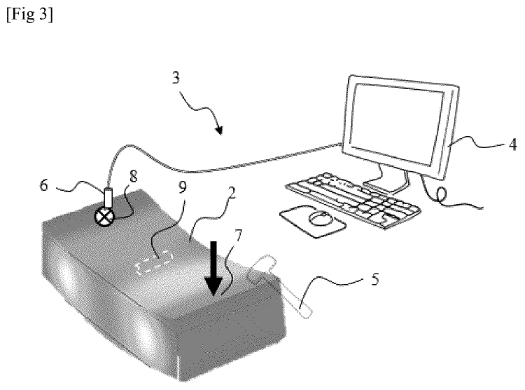

FIG. 3 shows a detection device 3 according to the invention, in a service position. This device comprises a computer 4, a resonator 5, in the form of a hammer, and a receiver 6. This figure illustrates an optimum loading mode for the block 2 of FIG. 2. It is possible to see the excitation zone 7 on which an impact, symbolized by the arrow, is produced, the output zone 8 and the region of interest 9.

The characteristics of the excitation wave are not limited. The excitation wave may in particular be a pulse, a succession of pulses, a periodic or non-periodic signal, or a succession of such signals.

It may be a sinusoidal wave, for example injected by way of a piezoelectric disk, as described in U.S. Pat. No. 6,330,827B1.

Conventional spectral analysis of the output wave generates a frequency spectrum comprising a set of peaks. The apex of the highest peak, or “main peak”, is located at what is referred to as a “resonant” frequency.

A loading mode “activates” a resonant mode when the frequency spectrum of the output wave has a peak at the resonant frequency of this mode. A loading mode is theoretically able to activate only a single resonant mode. In practice, and in particular for a part with a complex shape, a loading mode activates multiple resonant modes with a greater or lesser intensity. A loading mode “primarily activates” a resonant mode when, on the frequency spectrum, the highest peak is at the resonant frequency of this resonant mode.

The excitation wave is preferably chosen so as to primarily activate the optimum resonant mode.

The optimum resonant frequency depends in particular on the dimensions and the shape of the part. Preferably, the excitation wave is chosen such that its frequency spectrum has a main peak centered on a main frequency greater than 1 Hz, preferably greater than 50 Hz, preferably greater than 100 Hz, and/or less than 100 kHz, preferably less than 50 KHz.

Preferably, the excitation wave is chosen such that the main peak of the frequency spectrum of the output wave is centered on a main frequency greater than 1 Hz, preferably greater than 50 Hz, preferably greater than 100 Hz, and/or less than 100 kHz, preferably less than 50 KHz.

The resonator for injecting the excitation wave may be for example a hammer, a shaker or a piezoelectric transducer. The resonator may also be spaced from the part, for example be an audio loudspeaker. The resonator may be a heater for injecting an excitation wave in the form of a thermal flash or a laser wave.

In practice, the excitation wave may be injected into the part by impact, for example by a series of impacts in the injection zone, or “impact zone”. An impact advantageously makes it possible to inject an excitation wave having a wide frequency spectrum.

A hammer made of a hard material, for example silicon carbide, makes it possible to inject an excitation wave the frequency spectrum of which has high peaks for high frequencies. Such a hammer is well-suited to small parts.

A hammer made of a soft material, for example rubber, makes it possible to inject an excitation wave the frequency spectrum of which has high peaks for low frequencies. Such a hammer is well-suited to large parts.

Simple tests make it possible to choose a suitable hammer.

The receiver arranged in the output zone for picking up the output wave may be for example a detection or reception transducer, in particular a microphone, an accelerometer, a fast camera or a laser.

Preferably, the excitation wave is a periodic wave having the optimum resonant frequency, or a wave the main frequency of which is the optimum resonant frequency.

Simple tests, which are optionally computer-simulated, make it possible to determine a loading mode that primarily activates the optimum resonant mode, that is to say the optimum loading mode.

To guide these tests, it is possible to initially space the output zone from the injection zone as far as possible, while however placing these zones in zones in which the mechanical stresses are high. By moving the injection zone, it is possible to observe the evolution of the size of the peaks on the successive frequency spectra. It is therefore sufficient to move the injection zone until the height of the peak centered on the optimum resonant frequency is greater than the height of the other peaks. Preferably, this movement is continued to a position in which this peak is detached as much as possible from the other peaks, that is to say to a position that activates the other resonant modes as little as possible.

Preferably, the injection zone is chosen to be as close as possible to the region of interest.

The direction of injection of the excitation wave, or “impact direction”, is preferably substantially parallel to the main direction of deformation in the optimum resonant mode.

When the region of interest has a generally flattened shape, the impact direction is preferably substantially perpendicular to the general plane along which the region of interest extends. Preferably, it forms with this general plane an angle of less than 30°, preferably less than 20°, preferably less than 10°. For example, to detect a crack, the impact direction is preferably perpendicular to the plane of the crack.

Preferably, the part to which a loading mode is applied is arranged on a support configured to remain as close as possible to free vibration conditions and to minimize the effects of weight and contact with the support. Preferably, the part is placed on a foam. Preferably, the part rests on its most rigid parts. For example, if the part is a forehearth tank, it is preferable for it to rest on its base. Again preferably, the bearing points on the support are at vibration nodes.

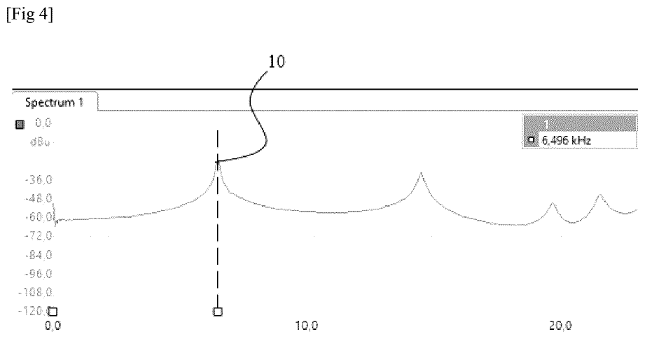

FIG. 4 shows the frequency spectrum of the output wave in the optimum loading mode illustrated in FIG. 3. It is possible to see in particular the main peak 10 centered on the optimum resonant frequency of 6496 kHz of the resonant mode shown in FIG. 3.

In one embodiment, steps a) and b) are carried out simultaneously, the optimum loading mode being sought as follows:
numerically simulating a plurality of loading modes, the numerical simulation determining, for each loading mode, a mechanical stress field in the reference part and a theoretical output wave;
analyzing the mechanical stress fields and the theoretical output waves so as to select, as optimum loading mode, the loading mode that generates, in the region of interest, a maximum mechanical stress and sets the reference part in resonance.

The reference part is considered to be resonating if the frequency spectrum of the output wave exhibits a main peak the height (amplitude of the output wave) of which is at least 1.5 times, preferably at least twice, preferably at least three times greater than that of the other peaks.

It is possible to use software that is capable, based on a model of the reference part, of calculating the mechanical stress fields and of simulating an output wave at an output zone under the effect of a simulation of an excitation wave in an excitation zone of said reference part.

In step c), the output waves obtained in the optimum loading mode for the reference part and the part to be tested are analyzed. The same nonlinear resonant spectrometry analysis is carried out for both parts. This analysis is based on the principles of the NRAS or NRUS methods.

This analysis is conventional and known to those skilled in the art. It makes it possible to determine a nonlinearity parameter representative of the variation in the modulus of elasticity of the part when the amplitude of the excitation wave of the optimum loading mode determined in step b) is modified.

U.S. Pat. No. 6,330,827B1 provides details about nonlinear resonant ultrasound spectrometry analysis.

The amplitude of the output wave follows the evolution of the amplitude of the excitation wave. Varying the amplitude of the excitation wave is therefore equivalent to changing the amplitude of the output wave. However, the output wave is easier to analyze, and is therefore used in practice.

In practice, a nonlinearity parameter representative of a variation in the resonant frequency of the part when the amplitude of the output wave varies is therefore chosen.

Preferably, the nonlinearity parameter is representative of a variation in a frequency offset of the resonant frequency with respect to the optimum resonant frequency f₀, when the amplitude of the output wave varies from the optimum loading mode.

In practice, the amplitude of the excitation wave is preferably increased gradually in order to limit the negative influence of hysteresis phenomena. The initial amplitude of the excitation wave or of the output wave is preferably chosen to be as small as possible, but sufficient for the noise measured in the output wave to be relatively negligible, for example to be greater than 2 times or 3 times the amplitude of the noise. It is then increased, preferably to a final amplitude at least 2 times, preferably at least 3 times, or even at least 5 or 10 times greater than the initial amplitude.

The frequency offset is preferably, for an amplitude of the output wave, the ratio of the absolute value of the difference between the optimum resonant frequency fₒ and the resonant frequency f determined for said amplitude, divided by fₒ, that is to say ||fₒ−f|/fₒ. The resonant frequency f may be determined conventionally through spectral analysis, being the frequency of the highest peak.

The frequency offsets are preferably calculated as described in U.S. Pat. No. 6,330,827B1.

The nonlinearity parameter is preferably the slope of a straight line representative of the evolution of the frequency offset when the amplitude of the output wave varies, in particular linearly or logarithmically. Said straight line is preferably the straight line that defines the general direction of the broken line that connects a plurality of points each giving an amplitude of the output wave and the corresponding frequency offset. It is preferably determined through linear regression.

The slope of this straight line is impacted by the presence of a defect in the part, this being exploited in order to determine the presence of a defect.

The nonlinearity parameter, in particular said slope, depends not only on the dimensions, the shape and the constituent material of the part under analysis, but also on the dimensions and the nature of the defect.

A difference between the nonlinearity parameters determined for the reference part and for the part to be tested thus makes it possible to detect the presence of a defect in the part to be tested. The inventors have discovered that a method according to the invention makes it possible to increase the reliability of this detection.

In step d), this difference is used to detect the possible presence of a defect, for example a crack.

Indeed, the inventors have observed that the nonlinearity parameter is particularly different depending on whether or not a part exhibits a defect in the region of interest.

The part to be tested may thus be classified in the category of parts exhibiting a defect in the region of interest or in the category of parts not exhibiting a defect in the region of interest. In one embodiment, said part is discarded if it exhibits a defect.

According to the experience acquired by the inventors, the slope, in terms of absolute value, determined for a part to be tested exhibiting a defect, is greater by more than 50%, or even more than 100%, than that measured on a part to be tested not exhibiting a defect.

In one embodiment, tests are used to determine a maximum slope and/or a minimum slope in order to delimit an acceptance range for the part to be tested.

### EXAMPLES

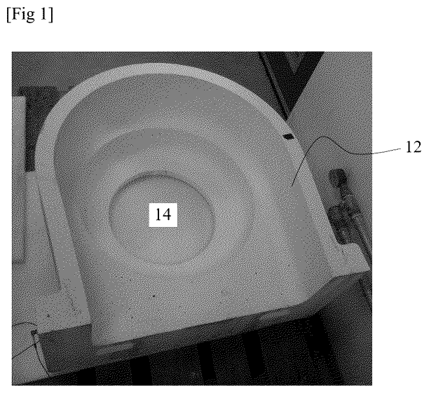

The following examples are provided for illustrative purposes and do not limit the invention. According to a first example, the part to be tested is a glass furnace forehearth tank 12, made of sintered refractory material based on alumina zirconia silica grains (see FIG. 1). Tests have shown that this type of tank may exhibit radial cracks that are not visible from the outside, extending from the tap hole 14.

The region of interest has therefore been defined as a region extending around the periphery of the tap hole.

A model of the reference part was created with the COMSOL® software. The mesh of the model was determined so as to include at least one point in the region of interest.

The bulk density, the modulus of elasticity at 20° C. and the Poisson's ratio of the refractory material constituting the reference part are 2.6 Kg/m³, 38 GPa and 0.2, respectively. These data were entered into the software.

The software was then parameterized so that the surface of the enriched model represents the von Mises stresses. This enrichment makes it possible to highlight local tension/compression phenomena along with shear stresses.

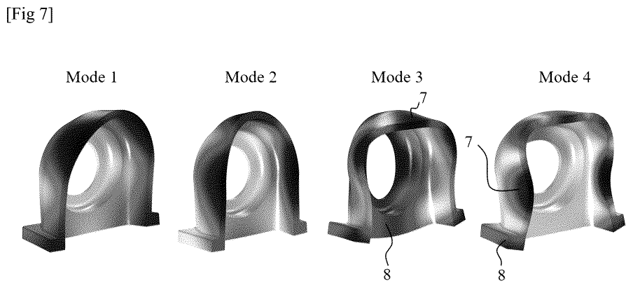

The software then determined four resonant modes and the corresponding resonant frequencies, namely 280 Hz, 366 Hz, 876 Hz, and 1040 Hz. The corresponding enriched models are shown in FIG. 7. The surface of the model is darker the greater the local mechanical stresses (or equivalently, the local deformation). The enriched model of resonant mode no. 3 is the one that shows the greatest amplitude of deformation around the tap hole, in the region of interest. Resonant mode no. 3 is therefore optimum.

Among the other resonant modes, resonant mode no. 4 is the one that has the highest resonant frequency and leads to the greatest mechanical stresses. However, it is not optimum according to the invention, since these mechanical stresses are not localized in the region of interest. It is chosen as a comparative example.

In FIG. 7, the reference 7 indicates the injection zone and the reference 8 indicates the output zone. The excitation waves were injected by striking the injection zone with an acoustic hammer. The output wave was picked up with an accelerometer in the output zone 8.

The loading mode for resonant mode no. 3 was applied in 8 parts of the same production.

For each part, multiple tests were carried out, each time modifying the amplitude of the excitation wave, and therefore the amplitude of the output wave. A frequency spectrum (amplitudes according to frequencies) was produced for each received output wave. The resonant frequency was determined from this spectrum.

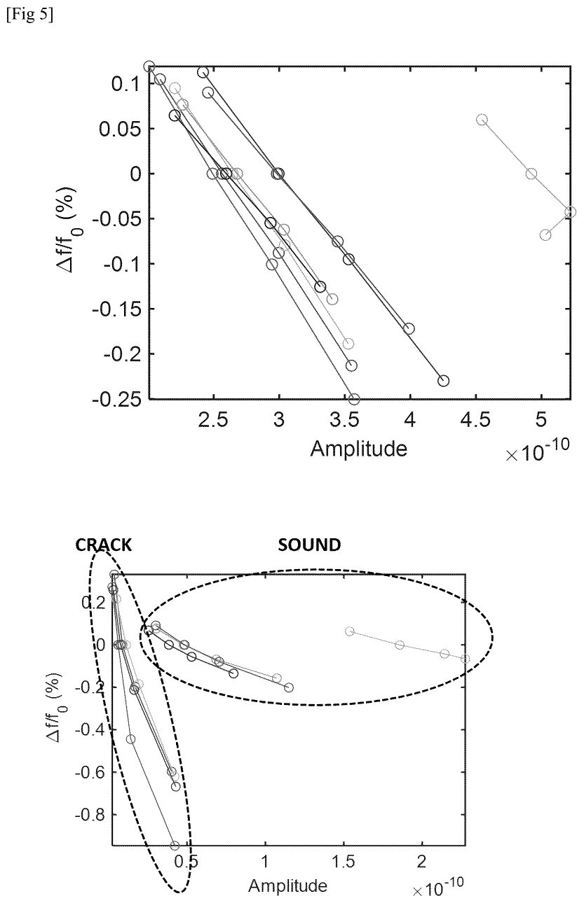

The frequency offset was then calculated for each part and for each output wave amplitude and a point giving the frequency offset as a function of the output wave amplitude was plotted (FIG. 5). Next, a straight line and the slope of this straight line were determined through linear regression with the points thus determined for one and the same part.

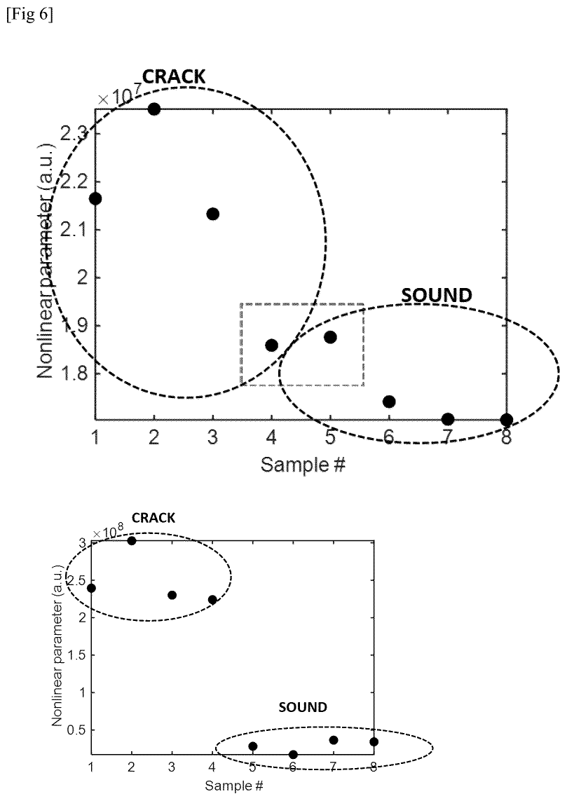

This slope is the nonlinearity parameter NL of the resonant frequency offset (f−fₒ)/fₒ as a function of the amplitude of the output wave. It is shown in FIG. 6.

The loading mode for resonant mode no. 4, that is to say primarily activating said resonant mode no. 4, was then brought about by striking the lateral portion 7 of the part using an acoustic hammer. The output wave was picked up in the lower left portion 8 of the part.

The nonlinearity parameter was then determined for each part, as described above for optimum resonant mode no. 3.

Each part was then cut in order to observe its internal structure and check for the presence or absence of cracks.

FIGS. 5 and 6 illustrate the results that were obtained, the graph on the left corresponding to resonant mode no. 4 and the graph on the right corresponding to optimum resonant mode no. 3. In FIG. 5, the amplitudes of the output waves are provided on the abscissa and the frequency offsets are provided on the ordinate. In FIG. 6, the numbers of the samples are provided on the abscissa and the nonlinearity parameters are provided on the ordinate.

These figures show that the invention considerably improves the discrimination between parts having cracks and those that are free from cracks.

According to a second example, substantially rectangular parallelepipedal refractory blocks E1-E5 with a thickness of 95 mm, a width of around 135 mm and a length of 500 mm, consisting of corundum bonded by a silicon nitride phase, were manufactured.

Samples were taken and allowed the following observations:
Block E1 had an internal structure without any visible internal defects.
Blocks E2, E3 and E4 had the same external appearance as block E1, but an internal structure with a gray or black core, this posing no problem in application.
Block E5 had the same external appearance as block E1, but an internal structure with a black or gray core and internal cracks liable to weaken the product during service.

The region of interest is therefore the core of the block, which is susceptible to cracking.

The characterization of the 5 blocks shows that they have a similar bulk density of 3.2+/−0.1 g/cm³, a modulus of elasticity of around 50 GPa for a Poisson's ratio of 0.2. Blocks E2, E3 and E4 have a metal silicon content (chemical analysis based on samples taken from the core of the block) of around 1%. Blocks E1 and E5 have a residual Si content of less than 0.5% by mass.

Numerical simulation using COMSOL® software, carried out as described in the above example, made it possible to identify the optimum resonant mode, in this case a bending resonant mode.

Each block was then loaded in an optimum loading mode, the excitation wave being injected by the impact of a hammer at one end of the block, on the edge of a major face, with the receiver, in this case a microphone, being positioned at the opposite end. As in the previous example, the amplitude of the excitation wave was then increased in order to determine the nonlinearity parameters.

The results are given in Table 1 below.

Each block has its own acoustic signature, and in particular its own main resonant frequency (frequency of the highest peak on the frequency spectrum of the output wave). It may be seen that the main resonant frequency alone, even in the optimum loading mode, does not make it possible to specifically detect block E5.

On the other hand, it is observed that the nonlinearity parameter NL makes it possible to specifically detect block E5, because the nonlinear resonant spectrometry analysis was carried out based on the optimum resonant mode, which is focused on the core of the blocks.

TABLE 1

| Block | E1 | E2 to E4 | E3 |
|---|---|---|---|
| First resonant | 1050 | 1120 to 1180 | 1150 |
| frequency (Hz) | | | |
| Nonlinearity | 5 | 6 to 10 | 18 |
| parameter NL | | | |
| Observation | No defect | << Black core >> | << Black core >> |
| | visible | | with cracks |

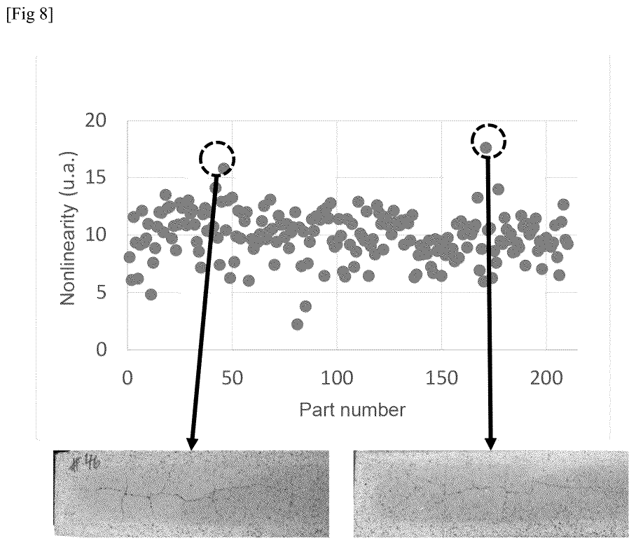

To discard non-compliant (cracked) blocks, a threshold of 15 was set for the nonlinearity parameter. As shown in FIG. 8, the nonlinearity parameter was then measured on a population of refractory blocks of nitride-bonded corundum having the same dimensions as the blocks described above, which were loaded in the optimum loading mode described above.

Samples were then taken and showed that this monitoring makes it possible, in a highly selective manner, to discard the cracked blocks, all of which have a nonlinearity parameter greater than the threshold of 15. On the other hand, the non-cracked blocks all have a nonlinearity parameter less than the threshold of 15.

As is now clearly apparent, by virtue of the invention, no complex and expensive, destructive or non-destructive tests are needed to reliably determine the presence of a defect in the region of interest.

Advantageously, unlike methods using X-ray radiography or tomography in particular, a method according to the invention may be implemented on a production line easily and at low cost.

Of course, the invention is not limited to the embodiments described in detail above. In particular, it may be implemented in order to detect multiple defects in one and the same part to be tested.

1. A method for detecting a defect in a region of interest within a part to be tested, said method comprising the following successive steps:
a) for a reference part identical to the part to be tested but free from defects,
a1) determining a set of resonant modes each defining:
a resonant frequency of the reference part, considering that the modulus of elasticity of the reference part is constant, and
a field of mechanical stresses or deformations on and/or in the reference part that are generated when the reference part resonates at said resonant frequency;
a2) selecting the resonant mode, referred to as “optimum resonant mode”, that generates, in the region of interest, a maximum mechanical stress or deformation compared to the other resonant modes;
b) determining a loading mode, referred to as “optimum” loading mode, that primarily activates said optimum resonant mode, a loading mode defining at least an excitation wave, an injection zone where the excitation wave is injected into the reference part, and an output zone where an output wave resulting from the excitation wave passing through from the injection zone to the output zone is picked up;
c) carrying out nonlinear resonant spectrometry analysis based on the optimum loading mode, so as to determine a nonlinearity parameter for each of said part to be tested and reference part;
d) classifying the part to be tested on the basis of the difference between the nonlinearity parameters for the part to be tested and for the reference part.

2. The method as claimed claim 1, wherein, in step a1), the resonant modes are determined through numerical simulation, the modeling of the reference part taking into account the dimensions and the geometry of the reference part, the bulk density of the material constituting the reference part, the modulus of elasticity of said material, and the Poisson's ratio of said material.

3. The method as claimed in claim 1, wherein, in step a2), three-dimensional numerical models of the reference part are compared, said models each representing a field of said mechanical stresses or deformations generated when the reference part resonates at a respective resonant frequency.

4. The method as claimed in any one of the preceding claims, wherein the volume of the region of interest is less than 0.2 times and greater than 0.01 times the volume of the reference part.

5. The method as claimed in claim 1, wherein steps a) and b) are carried out simultaneously, the optimum loading mode being sought as follows:
numerically simulating a plurality of loading modes, the numerical simulation determining, for each loading mode, a mechanical stress field in the reference part and a theoretical output wave;
analyzing the mechanical stress fields and the theoretical output waves so as to select, as optimum loading mode, the loading mode that generates, in the region of interest, a maximum mechanical stress and sets the reference part in resonance.

6. The method as claimed in claim 1, wherein, in step c), the nonlinearity parameter is the slope of a straight line representative of the evolution of a frequency offset as a function of the evolution of the amplitude of the output wave when said amplitude of the output wave is modified, from the optimum loading mode,
the frequency offset, for an amplitude of the output wave, being the ratio of the absolute value of the difference between the optimum resonant frequency (fₒ) in the optimum resonant mode and the resonant frequency (f) determined for said amplitude of the output wave, divided by the optimum resonant frequency (fₒ).

7. The method as claimed in claim 7, wherein, in step d), the nonlinearity parameter of the part to be tested is compared with a threshold determined based on the nonlinearity parameter of the reference part, and the part to be tested is then classified on the basis of the difference between the nonlinearity parameter of the part to be tested and the threshold.

8. The method as claimed in claim 1, wherein the defect is an empty space within the part to be tested, or a space filled with a material different from the rest of the part to be tested.

9. The method as claimed claim 1, wherein the part is made of an inorganic material.

10. The method as claimed in claim 1, wherein the part is made of a metal, a ceramic material, a glass-ceramic material, a glass or a mixture of these materials.

11. The method as claimed in claim 1, wherein, in the optimum loading mode, the main peak of a frequency spectrum of the output wave is at a frequency between 1 Hz and 100 kHz.

12. The method as claimed in claim 1, wherein the output wave is an acoustic wave.

13. The method as claimed in claim 1, wherein said part to be tested is chosen from:
a throat lintel or block,
a soldier block,
a refractory brick or sidewall block,
a corner block,
a tuckstone,
a paving tile or pavement,
a crown brick or beam,
a tuyere surround block or brick,
a brick for a tapping hole or spout,
an electrode block,
a refractory spout-lip for a glass furnace,
a block for an injector,
a glass furnace throat,
a part for a heat exchanger of a furnace,
a boiler lining refractory tile or plate,
a shell for protecting a heater tube for an incinerator,
an incinerator tile,
a ceramic part for a solar absorber,
a protective part or tile for a turbine combustion chamber.

14. A method for sorting externally identical parts manufactured on a production line, wherein a method as claimed in claim 1 is implemented for each part, considered to be a part to be tested, steps a) and b) and the nonlinear resonant spectrometry analysis based on the optimum loading mode carried out on the reference part.

15. A detection device intended to detect a defect in a part to be tested, the device comprising:
a resonator able to inject, into the part to be tested, an excitation wave through an injection zone of the part to be tested;
a receiver able to pick up an output wave through an output zone of the part to be tested, the output wave resulting from the excitation wave passing through the part to be tested;
a computer connected to the receiver so as to receive the output wave, the computer having a memory storing a nonlinearity parameter resulting from nonlinear resonant spectrometry analysis carried out, in accordance, the method of claim 1, with step c) based on an optimum loading mode determined in accordance with steps a) and b) for a reference part identical to the part to be tested but free from defects, the computer being programmed to
carry out said nonlinear resonant spectrometry analysis for the part to be tested, based on the optimum loading mode in accordance with step c), so as to determine the nonlinearity parameter for said part to be tested, and then,
in accordance with a step d).
determine a difference between the nonlinearity parameters for the part to be tested and for the reference part, and then
classify the part to be tested on the basis of said difference.
